(19) United States
(12) Patent Application Publication
(10) Pub. No.: US 2026/0319420 A1
(43) Pub. Date: Oct. 15, 2026

(54) IMAGE FORMING APPARATUS

(71) Applicant: CANON KABUSHIKI KAISHA, Tokyo (JP)

(72) Inventors: HAJIME SEKIGUCHI, Chiba (JP); KOUYOU TAMURA, Chiba (JP); SEIYA FUJIYAMA, Chiba (JP)

(21) Appl. No.: 19/571,985

(22) Filed: Mar. 19, 2026

(30) Foreign Application Priority Data
Apr. 9, 2025 (JP) 2025-064099

(51) Int. Cl. G03G 15/00; B65H 1/04

(52) U.S. Cl. CPC G03G 15/6502; B65H 1/04; G03G 15/6594; B65H 2405/15; G03G 2215/00383; G03G 2215/00447; G03G 2215/00924

(57) ABSTRACT

An image forming apparatus including a plurality of cassettes is provided. The plurality of cassettes includes a first cassette configured to store sheets of a first size to be fed to the image forming unit, a second cassette configured to store sheets of the first size to be fed to the image forming unit, the second cassette being disposed on one side of the first cassette in a horizontal direction, and a third cassette configured to store sheets of a second size larger than the sheets of the first size to be fed to the image forming unit, the third cassette being disposed below the first cassette and the second cassette. A height of each of the first cassette and the second cassette in a vertical direction is greater than three times a height of the third cassette in the vertical direction.

### BACKGROUND

### Field of the Technology

The present disclosure relates to an image forming apparatus that forms an image on a sheet.

### DESCRIPTION OF THE RELATED ART

There has been proposed an image forming apparatus in which a plurality of decks for stacking sheets are arranged not only vertically but also transversely (horizontally) below an image forming unit to increase the sheet capacity and reduce the space required for installing the apparatus (see JP H09-20434 A).

Further, there has been proposed an image forming apparatus in which parts of a frame are standardized so that one of a sheet feeding unit and a toner collection unit can be selectively attached to the frame, thereby reducing the cost (see JP 2022-1926 A).

Meanwhile, in the image forming apparatus, in a case where a plurality of decks (cassettes) are arranged in such a manner as not to increase the size of the apparatus, it is necessary to arrange the plurality of decks (cassettes) within a certain space. However, if the number of times of replenishment of sheets increases, this may result in a decrease in productivity.

### SUMMARY

Therefore, the present disclosure provides an image forming apparatus capable of improving productivity without causing an increase in size.

Note that the problems to be solved by the embodiments disclosed in the present specification and the drawings are not limited to the above-described problems. The problems corresponding to the respective effects achieved by the configurations of the embodiments to be described below can also be positioned as other problems.

According to a first aspect of the present disclosure, an image forming apparatus includes an image forming unit configured to form an image on a sheet, a plurality of cassettes configured to store one or more sheets to be fed to the image forming unit, and a casing including an image forming installation portion in which the image forming unit is installed, and a cassette installation portion in which the plurality of cassettes are attached and installed, the cassette installation portion being disposed below the image forming installation portion. The plurality of cassettes includes a first cassette configured to store one or more sheets of a first size to be fed to the image forming unit, a second cassette configured to store one or more sheets of the first size to be fed to the image forming unit, the second cassette being disposed on one side of the first cassette in a horizontal direction, and a third cassette configured to store one or more sheets of a second size larger than the sheets of the first size to be fed to the image forming unit, the third cassette being disposed below the first cassette and the second cassette. A height of each of the first cassette and the second cassette in a vertical direction is greater than three times a height of the third cassette in the vertical direction.

According to a second aspect of the present disclosure, an image forming apparatus includes an image forming unit configured to form an image on a sheet, a plurality of cassettes configured to store one or more sheets to be fed to the image forming unit, and a casing including an image forming installation portion in which the image forming unit is installed, and a cassette installation portion in which the plurality of cassettes are attached and installed, the cassette installation portion being disposed below the image forming installation portion. The plurality of cassettes includes a first cassette configured to store one or more sheets of a first size to be fed to the image forming unit, a second cassette configured to store one or more sheets of the first size to be fed to the image forming unit, the second cassette being disposed on one side of the first cassette in a horizontal direction, and a third cassette configured to store one or more sheets of a second size larger than the sheets of the first size to be fed to the image forming unit, the third cassette being disposed below the first cassette and the second cassette. A number of sheets stackable in each of the first cassette and the second cassette is greater than three times a number of sheets stackable in the third cassette.

According to a third aspect of the present disclosure, an image forming apparatus includes an image forming unit configured to form an image on a sheet, a plurality of cassettes configured to store one or more sheets to be fed to the image forming unit, and a casing including an image forming installation portion in which the image forming unit is installed, and a cassette installation portion in which the plurality of cassettes are attached and installed, the cassette installation portion being disposed below the image forming installation portion. The plurality of cassettes includes a first cassette configured to store one or more sheets of a first size to be fed to the image forming unit, a second cassette configured to store one or more sheets of the first size to be fed to the image forming unit, the second cassette being disposed on one side of the first cassette in a horizontal direction, and a third cassette configured to store one or more sheets of a second size larger than the sheets of the first size to be fed to the image forming unit, the third cassette being disposed below the first cassette and the second cassette. The plurality of cassettes does not include a fourth cassette configured to store one or more sheets, the fourth cassette being disposed below the third cassette in a vertical direction.

Features of the present disclosure will become apparent from the following description of embodiments with reference to the attached drawings. The following description of embodiments is described by way of example.

### BRIEF DESCRIPTION OF THE DRAWINGS

FIG. 1 is an overall schematic view illustrating a first-type image forming apparatus according to a first embodiment.

FIG. 2 is an overall schematic view illustrating a second-type image forming apparatus according to the first embodiment.

FIG. 3 is a perspective view illustrating a vertical path conveyance unit.

FIG. 4 is a perspective view illustrating a feeding unit.

FIG. 5 is a perspective view illustrating a vertical path conveyance door.

FIG. 6 is a perspective view illustrating a main body frame to which a cassette feeding unit and a vertical path conveyance unit are attached.

FIG. 7A is a side view illustrating a main body frame from which a vertical path conveyance unit and a cassette feeding unit are detached.

FIG. 7B is an enlarged view illustrating a portion including a coupling drive gear.

FIG. 8 is an overall schematic view illustrating a third-type image forming apparatus according to a second embodiment.

### DESCRIPTION OF THE EMBODIMENTS

### First Embodiment

### Overall Configuration

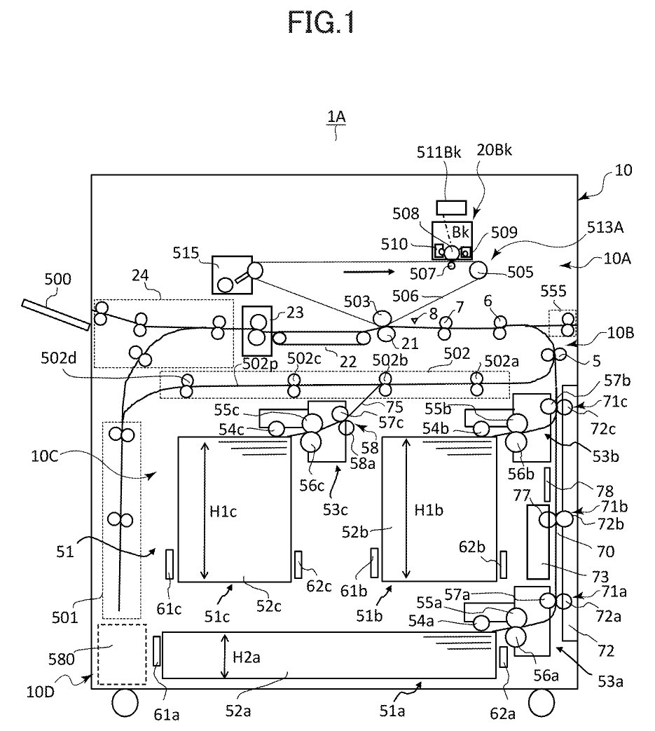

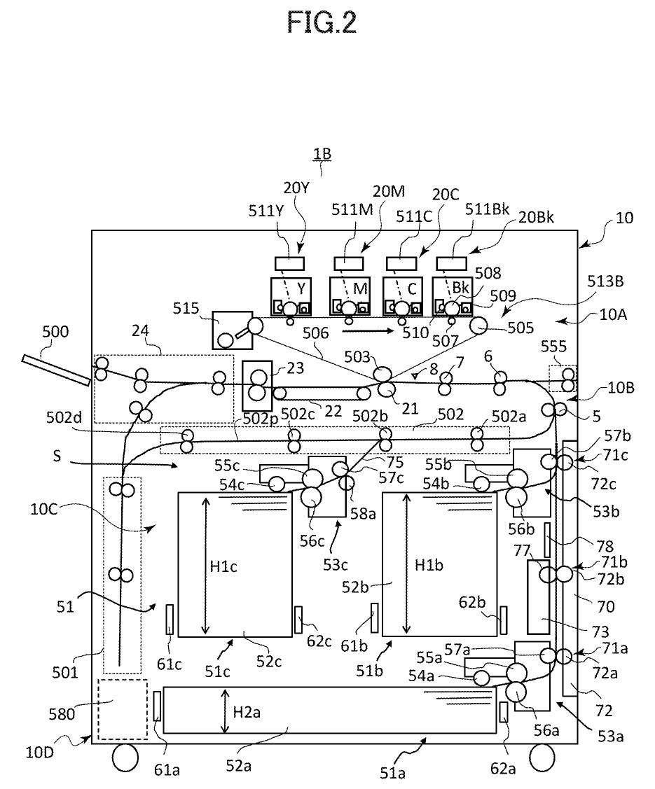

Hereinafter, the first embodiment will be described. In the present embodiment, a first-type image forming apparatus 1A and a second-type image forming apparatus 1B using a common casing 10, that is, using a main body frame 100 as a common frame, will be described. FIG. 1 is an overall schematic view illustrating a first-type image forming apparatus according to the first embodiment. FIG. 2 is an overall schematic view illustrating a second-type image forming apparatus according to the first embodiment.

The first-type image forming apparatus 1A is an electrophotographic monochrome laser beam printer that forms a monochrome (black and white) image on a sheet serving as a recording material based on image information read from a document or image information received from an external device. The second-type image forming apparatus 1B is an electrophotographic color laser beam printer that forms a color image on a sheet serving as a recording material based on image information read from a document or image information received from an external device. The sheet used as a recording material or a document includes paper such as plain paper and thick paper, a plastic film such as a sheet for an overhead projector, cloth, a sheet material subjected to surface treatment such as coated paper, and a sheet material having a special shape such as an envelope or index paper.

### First-Type Image Forming Apparatus

First, the overall configuration of the first-type image forming apparatus 1A will be described. As illustrated in FIG. 1, the image forming apparatus 1A includes a casing 10 having a main body frame 100 therein. The casing 10 roughly includes, as internal spaces, an image forming installation portion 10A, a conveyance installation portion 10B, a cassette installation portion 10C, and a collection installation portion 10D. In addition, the image forming apparatus 1A includes a cassette feeding unit 51, an image forming unit 513A, a collected toner storage unit 580, a fixing unit 23, a branch conveyance unit 24, a reverse conveyance unit 501, and a double-sided printing conveyance unit 502.

The image forming unit 513A serving as a first image forming unit is installed in the image forming installation portion 10A of the casing 10. In addition, the fixing unit 23, the branch conveyance unit 24, the reverse conveyance unit 501, and the double-sided printing conveyance unit 502 are installed in the conveyance installation portion 10B of the casing 10. The cassette feeding unit 51 is installed in the cassette installation portion 10C of the casing 10. The collected toner storage unit 580 is installed in the collection installation portion 10D of the casing 10. Note that toner removed from a photosensitive drum 508 and an intermediate transfer belt 506 is conveyed to the collected toner storage unit 580 via a collected toner conveyance portion.

The image forming unit 513A that forms a monochrome image includes an exposing unit 511Bk and a process cartridge 20Bk that forms a black (K) image.

The exposing unit 511Bk irradiates the photosensitive drum 508 of the process cartridge 20Bk with laser light based on input image information. At this time, the photosensitive drum 508 is charged in advance by a charger, and an electrostatic latent image is formed on the photosensitive drum 508 when irradiated with laser light. Thereafter, the electrostatic latent image is developed by a photosensitive developer 510, and a black (Bk) toner image is formed on the photosensitive drum 508.

The toner image formed on the photosensitive drum 508 is transferred to the intermediate transfer belt 506 by a primary transfer roller 507, and is conveyed to a secondary transfer inner roller 503 by the rotating intermediate transfer belt 506. Adhering substances such as residual transfer toner remaining on the photosensitive drum, not transferred to the intermediate transfer belt 506, are removed by a cleaner 509.

In parallel with the above-described image forming process, a sheet is fed from the cassette feeding unit 51 or an external receiving unit 555. The external receiving unit 555 is normally covered with an exterior cover or the like, but the cover is removed, for example, when an external large-capacity deck is connected to the image forming apparatus 1A. Then, the external receiving unit 555 receives a sheet fed from the large-capacity deck. In this manner, when the sheet capacity of the cassettes built in the image forming apparatus 1A alone is not sufficient for user's printing work, the large-capacity deck is connected to the image forming apparatus 1A.

The cassette feeding unit 51 according to the present embodiment includes a cassette unit 51a having a large-size cassette 52a disposed in a lower portion. In addition, the cassette feeding unit 51 according to the present embodiment includes two cassette units 51b and 51c having small-size cassettes 52b and 52c disposed above the cassette 52a and arranged side by side in the horizontal direction. The sizes of the cassette units 51a, 51b, and 51c (cassettes 52a, 52b, and 52c) will be described below. That is, the cassette 52c is disposed on one side of the cassette 52b in the horizontal direction, and the cassette 52a is disposed on one side of the cassettes 52b and 52c in the vertical direction.

The lower cassette unit 51a includes left and right guide rails 61a and 62a, a cassette 52a serving as a third cassette that stores one or more sheets, and a feeding unit 53a serving as a third feeding unit that feeds the sheets stored in the cassette 52a. The cassette 52a is supported by the guide rails 61a and 62a in a drawable manner. In the vertical direction, a fourth cassette that stores one or more sheets is not disposed below the cassette 52a serving as the third cassette.

The feeding unit 53a includes a pickup roller 54a that feeds the uppermost sheet from the cassette 52a, a feed roller 55a that receives the sheet from the pickup roller 54a and conveys the received sheet, and a retard roller 56a that abuts on the feed roller 55a. A driving force in a direction opposing the rotation of the feed roller 55a is input to the retard roller 56a via a torque limiter. The retard roller 56a applies a frictional force in a direction opposite to the feeding direction to a sheet entering a separation nip between the feed roller 55a and the retard roller 56a, thereby pushing back one or more sheets other than the uppermost sheet to the cassette 52a.

The sheet separated and fed one by one from the cassette 52a by the feeding unit 53a are conveyed by vertical path roller pairs 71a, 71b, and 71c along a vertical path 70 serving as a first conveyance path and delivered to a merging roller pair 5. That is, the vertical path 70 is arranged so as to extend in the vertical direction on the other side of the cassette 52b in the horizontal direction, and conveys the sheet toward the image forming unit 513A.

The vertical path roller pair 71a includes a vertical path roller 57a included in the feeding unit 53a, and a driven roller 72a serving as a third roller included in a vertical path conveyance door 72, which will be described below, and driven to rotate following the vertical path roller 57a serving as a third conveyance roller. In addition, the vertical path roller pair 71bincludes a vertical path roller 77 serving as a second conveyance roller included in a vertical path conveyance unit 73, which will be described below in detail, and a driven roller 72b serving as a second roller included in the vertical path conveyance door 72, which will be described below, and driven to rotate following the vertical path roller 77. In addition, the vertical path roller pair 71cincludes a vertical path roller 57b serving as a first conveyance roller included in a feeding unit 53b, which will be described below, and a driven roller 72c serving as a first roller included in the vertical path conveyance door 72, which will be described below, and driven to rotate following the vertical path roller 57b.

The cassette unit 51b located on the right side when viewed from the front of the upper level includes left and right guide rails 61b and 62b, a cassette 52b serving as a first cassette that stores one or more sheets, and a feeding unit 53b serving as a first feeding unit that feeds the sheets stored in the cassette 52b. The cassette 52bis supported by the guide rails 61b and 62b in a drawable manner. The feeding unit 53b includes a pickup roller 54b, a feed roller 55b, and a retard roller 56b, and has the same configuration as the feeding unit 53a described above. Thus, the detailed description thereof will be omitted.

The sheet separated and fed one by one from the cassette 52b by the feeding unit 53b are conveyed by the vertical path roller pair 71c serving as a first conveyance roller along the vertical path 70 and delivered to the merging roller pair 5.

The cassette unit 51c located on the left side when viewed from the front of the upper level includes left and right guide rails 61c and 62c, a cassette 52c serving as a second cassette that stores one or more sheets, and a feeding unit 53c serving as a second feeding unit that feeds the sheets stored in the cassette 52c. The cassette 52cis supported by the guide rails 61c and 62c in a drawable manner. The feeding unit 53calso includes a pickup roller 54c, a feed roller 55c, and a retard roller 56c, and has the same configuration as the feeding unit 53a and the feeding unit 53b described above. Thus, the detailed description thereof will be omitted.

The sheet separated and fed one by one from the cassette 52c by the feeding unit 53c are conveyed by a relay path roller pair 58 and conveyance roller pairs 502b and 502a along a relay path 75 and a double-sided printing path 502p serving as a second conveyance path and delivered to the merging roller pair 5.

The relay path roller pair 58 includes a driving roller 57c included in the feeding unit 53c and a driven roller 58a included in the feeding unit 53c and driven to rotate following the driving roller 57c.

Note that the feeding units 53a, 53b, and 53c described above are examples of sheet feeding devices that feed sheets, and for example, may use an air feeding method in which the uppermost sheet is adsorbed to the belt to feed the sheet by sucking air. In addition, a pad-shaped friction member may be used instead of the retard roller as a separation member that separates the fed sheets one by one.

The sheet sent from the cassette feeding unit 51 or the external receiving unit 555 passes through the merging roller pair 5 and a pre-registration roller pair 6, and is conveyed to a registration roller pair 7. The skew of the sheet is corrected by the registration roller pair 7, and the sheet is conveyed at a predetermined conveyance timing. For example, the speed of the sheet is temporarily increased by the registration roller pair 7, and is decreased when a sheet detection sensor 8 detects a leading edge of the sheet. In this manner, the timing of the sheet is adjusted so that the image forming position on the sheet is aligned with the toner image formed on the intermediate transfer belt 506.

Then, the toner image formed on the intermediate transfer belt 506 is transferred to the sheet by the secondary transfer inner roller 503 and a secondary transfer outer roller 21. Adhering substances such as residual transfer toner remaining on the intermediate transfer belt 506, not transferred to the sheet, are removed by a belt cleaner 515. The sheet to which the toner image has been transferred is conveyed by a belt conveyance member 22, and predetermined heat and pressure are applied to the sheet in the fixing unit 23 to melt and fix the toner. The sheet having passed through the fixing unit 23 is discharged to the outside of the apparatus by the branch conveyance unit 24, and is stacked on a sheet discharge tray 500.

In a case where images are formed on both sides of a sheet, the sheet having passed through the fixing unit 23 after the image is formed on the first side is conveyed to the reverse conveyance unit 501 by the branch conveyance unit 24. The sheet is conveyed in a switchback manner by the reverse conveyance unit 501, whereby the conveyance direction is reversed. The sheet of which the conveyance direction has been reversed is conveyed along the double-sided printing path 502p in the double-sided printing conveyance unit 502 by conveyance roller pairs 502d, 502c, 502b, and 502a, and is conveyed back to the registration roller pair 7. As a result, the sheet is conveyed in a state where its front and back sides are reversed such that the second side opposite to the first side faces the intermediate transfer belt 506, and the toner image is transferred to the second side by the secondary transfer inner roller 503 and the secondary transfer outer roller 21.

Note that the image forming unit 513A provided in the image forming apparatus 1A according to the present embodiment is an example of an image forming unit that forms an image on a sheet. As another image forming unit, for example, a direct transfer-type electrophotographic unit that transfers a toner image from a photosensitive member to a sheet without passing through an intermediate transfer member may be used. In addition, an image forming unit other than an electrophotographic image forming unit, such as an inkjet-type image forming unit or an offset printing-type printing mechanism, may also be used.

### Second-Type Image Forming Apparatus

Next, a second-type image forming apparatus 1B will be described with reference to FIG. 2. FIG. 2 is an overall schematic view illustrating a second-type image forming apparatus according to the first embodiment.

A second-type image forming apparatus 1B is obtained by replacing the monochrome image forming unit 513A in the first-type image forming apparatus 1A with a color image forming unit 513B. That is, the image forming apparatus 1B is an electrophotographic color laser beam printer that forms a color image on a sheet serving as a recording material based on image information read from a document or image information received from an external device.

Specifically, the image forming unit 513B serving as a second image forming unit is installed in the image forming installation portion 10A of the casing 10. The image forming unit 513B includes exposing units 511Y, 511M, 511C, and 511Bk, and four process cartridges 20Y, 20M, 20C, and 20Bk that form images of four colors: yellow (Y), magenta (M), cyan (C), and black (K). The four process cartridges 20Y to 20Bk have a common configuration except that colors of images to be formed are different. Note that the process cartridges 20Y to 20Bk have the same configuration as the process cartridge 20Bk in the monochrome image forming unit 513A described above, and thus the description of the process cartridges 20Y, 20M, and 20C will be omitted.

When an image is formed, toner images of yellow (Y), magenta (M), cyan (C), and black (K) are formed on photosensitive drums of the process cartridges 20Y, 20M, 20C, and 20Bk. The toner images of the respective colors formed on the respective photosensitive drums are transferred to the intermediate transfer belt 506 by the primary transfer roller 507, and a full-color toner image is formed on the intermediate transfer belt 506. The image forming process for each color is performed at a timing when a toner image is superimposed on an upstream toner image primarily transferred to the intermediate transfer belt 506. Then, the full-color toner image formed on the intermediate transfer belt 506 is conveyed to the secondary transfer inner roller 503, and is transferred to the sheet conveyed from the cassette feeding unit 51 by the secondary transfer inner roller 503 and the secondary transfer outer roller 21 as described above.

The sheet to which the toner image has been transferred is conveyed by a belt conveyance member 22, and predetermined heat and pressure are applied to the sheet in the fixing unit 23 to melt and fix the toner. The sheet having passed through the fixing unit 23 is discharged to the outside of the apparatus by the branch conveyance unit 24, and is stacked on the sheet discharge tray 500. The other operations (e.g., a double-sided printing operation) are the same as those of the first-type image forming apparatus 1A, and thus the description thereof will be omitted.

### Standardization between First-Type Image Forming Apparatus and Second-Type Image Forming Apparatus

The first-type image forming apparatus 1A and the second-type image forming apparatus 1B described above have a configuration in which the monochrome image forming unit 513A and the color image forming unit 513B are interchanged, while the structures of the casing 10 and the main body frame 100 are standardized, thereby achieving cost reduction.

That is, the monochrome image forming unit 513A can be smaller than the color image forming unit 513B by adopting a configuration in which the intermediate transfer belt 506 is eliminated (a so-called direct transfer method), for example, as in JP H09-20434 A. However, considering the recent increase in demand for color machines and the recent decrease in demand for monochrome machines, it will be necessary in the future to promote standardization of parts between the monochrome machines and the color machines not only at a level of individual parts, but also at a level of the casing 10, the main body frame 100, and the like.

In the present embodiment, in order to standardize the structures of the casing 10 and the main body frame 100, the image forming installation portions 10A serving as internal spaces have a common size. Therefore, the cassette installation portions 10C also have a common size, and it is necessary to appropriately design the cassette installation portion 10C having this limited size to meet the needs of users.

On the other hand, in recent years, paper of B-series sizes (B5 size, B4 size, etc.) used in printers has been limited to some demands, while the proportion of paper of A-series sizes, particularly an A4 size (small size), has increased significantly. In addition, there is a certain degree of demand for an A3 size (large size) in order to create explanatory materials and the like. Therefore, in the present embodiment described below, a configuration is proposed in which two small-size (corresponding to an A4 size) cassettes and one large-size (corresponding to an A3 size) cassette are installed in the cassette installation portion 10C. This copes with an increase in demand for an A4 size in recent years, also copes with a demand for an A3 size, and meets the desire to efficiently use a sheet storage space.

### Details of Cassettes

In the image forming apparatus 1A or the image forming apparatus 1B according to the present embodiment, the sheet capacity (that is, the number of stackable sheets) for sheets of an A4 size (small size) serving as a first size set in the image forming apparatus is increased without changing the size of the casing 10. Further, the image forming apparatus 1A or the image forming apparatus 1B has a sheet capacity suitable for allowing sheets of an A3 size (large size) to be set as a second size. At the time of replenishing sheets, one commonly distributed pack (500 sheets) can be set at once.

That is, conventionally, there are many image forming apparatuses configured as in JP H09-20434 A, that is, an apparatus including two large-size cassettes and two small-size cassettes is common. However, in the present disclosure, one large-size cassette is provided, in other words, one large-size cassette is eliminated, to increase the sheet capacity of the two small-size cassettes. Specifically, one cassette (including about 60 mm for the stacking height) is eliminated, the feeding unit (parts around the pickup roller, a sheet conveyance detection unit, a sheet presence/absence detection unit, a feeding frame, etc.) is eliminated, and the gap between adjacent upper and lower cassettes is eliminated. As a result, it is possible to eliminate the stacking height of about 60 mm for one large-size cassette and the space of about 20 mm or more for other parts. Therefore, as illustrated in FIGS. 1 and 2, the sheet capacity heights (hereinafter, referred to as “stacking heights”) H1b and H1c of the cassettes 52b and 52c, which are two small-size cassettes, can be made about 186 mm.

In summary, in the image forming apparatus 1A or the image forming apparatus 1B according to the present embodiment, the cassettes 52b and 52c, which are small-size cassettes, are configured to have stacking heights H1b and H1c of about 186 mm. The cassette 52a, which is a large-size cassette, is configured to have a stacking height H2a of about 60 mm. The ratio between the sheet capacities of the cassettes 52b and 52c, which are small-size cassettes, and the cassette 52a, which is a large-size cassette, is about 3:1. Specifically, the cassettes 52b and 52c, which are small-size cassettes, have a height three times or more, preferably more than three times, the height of the cassette 52a, which is a large-size cassette, in the ratio of 186 mm to 60 mm (3.1 to 1). In addition, the stacking height of each of the cassettes 52a, 52b and 52c is determined depending on the number of sheets that can be stacked in each cassette.

Here, one commonly distributed pack of sheets generally contains 500 sheets. It is said that this number of sheets, 500 sheets, is a number suitable for use, because it does not make the pack too heavy when being carried, and is a nice round number. Therefore, it is said that sheets sold in units of one pack containing 500 sheets are most commonly distributed.

In addition, since one pack of sheets can be set all at once at the time of replenishment, it is possible to eliminate remaining sheets that cannot be set. That is, it is known that the sheets once taken out from the pack start to absorb moisture. In addition, if the remaining sheets are stored under poor conditions, the sheets absorb even more moisture. The progress of the moisture absorption of the sheets may lead to a deterioration in sheet shape, such as curling or waviness. Then, the deterioration in sheet shape causes a paper jam. In addition, uneven moisture absorption inside the sheet and a deterioration in performance of the sheet may lead to defects when the toner is transferred to the sheet. Therefore, the present embodiment intends to obtain an effect of reducing the causes of paper jams and image defects by making it possible to set an entire pack of sheets (500 sheets) all at once at the time of replenishing the cassettes 52a, 52b, and 52c.

In addition, for example, in a large-capacity cassette having a large stacking height, such as a large-capacity deck, the number of sheets (the number of packs) to be set at once can be increased, but the depth of the cassette is large. This may lead to an error in setting the sheets for a user who is unfamiliar with sheet replenishment. In addition, a large number of sheets is heavy in itself, which increases the impact at the time of taking in and out the sheets, making it necessary to enhance the rigidity of the sheet feeding unit and the cassette. Then, the impact increases at the time of inserting the cassette, which may cause the image forming unit to vibrate, leading to an occurrence of an image defect. For these reasons, the image forming apparatus 1A or 1B according to the present embodiment is designed such that the amount of sheets to be replenished into one of the cassettes 52b and 52c mounted in the casing 10 is about three or four packs.

For the reasons described above, in the image forming apparatus 1A or 1B according to the present embodiment, the cassette 52a, which is a large-size cassette, is designed to have the same sheet capacity as the conventional one, so that one pack of 500 sheets can be set therein. Further, the cassettes 52b and 52c, which are small-size cassettes, are designed to have a sheet capacity so that 1500 sheets, which are three packs, can be set therein.

In practice, the number of sheets stacked in the cassette is related to the sheet grammage, that is, the sheet thickness. For example, one sheet having a grammage of 80 GSM has a thickness of 0.105 mm. Therefore, the sheet capacity of the cassette 52a, which is a large-size cassette, is about 570 sheets (60 mm/0.105 mm), and the sheet capacity of the cassettes 52b and 52c, which are small-size cassettes, is about 1770 sheets (186 mm/0.105 mm). Assuming that one pack contains 500 sheets, the sheet capacity of the cassette 52a, which is a large-size cassette, is one pack and 70 sheets, and the sheet capacity of the cassettes 52b and 52c, which are small-size cassettes, is three packs and 270 sheets.

Further, for example, one sheet having a grammage of 64 GSM has a thickness of 0.089 mm. Therefore, the sheet capacity of the cassette 52a, which is a large-size cassette, is about 670 sheets (60 mm/0.089 mm), and the sheet capacity of the cassettes 52b and 52c, which are small-size cassettes, is about 2080 sheets (186 mm/0.089 mm). Assuming that one pack contains 500 sheets, the sheet capacity of the cassette 52a, which is a large-size cassette, is one pack and 170 sheets, and the sheet capacity of the cassettes 52b and 52c, which are small-size cassettes, is four packs and 80 sheets.

In this manner, the number of sheets to be stacked in each of the cassettes 52a, 52b and 52c is determined depending on the grammage of the sheet to be stacked in each cassette. That is, the number of sheets (the number of packs) that can be stacked in each cassette varies depending on the type of sheet such as a difference in grammage. However, in particular, the sheet capacity (volume) of the cassettes 52b and 52c remains unchanged. For this reason, for example, even if sheets having a large grammage are stacked in the cassette, it is not necessary to increase the rigidity of the cassette because the stacking weight of the cassette is the same when the cassette is fully loaded.

### Configuration Around vertical path

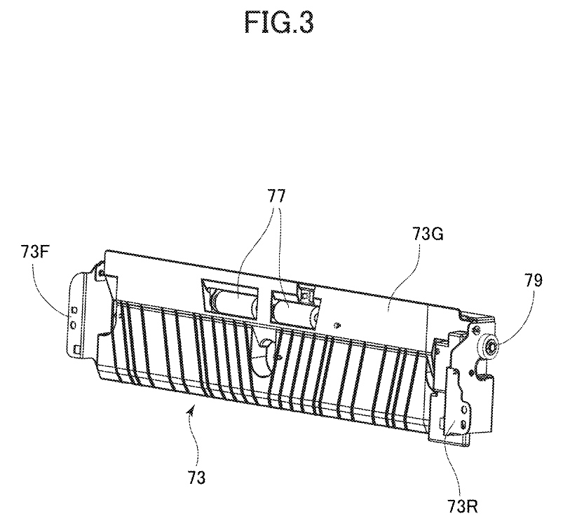

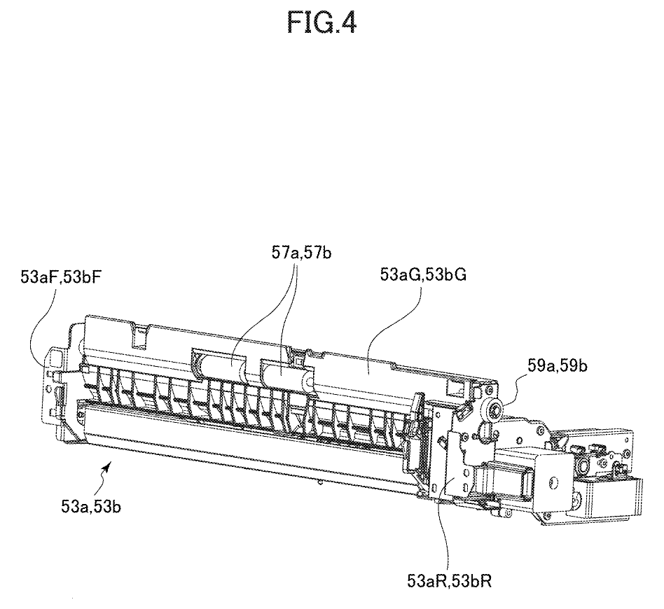

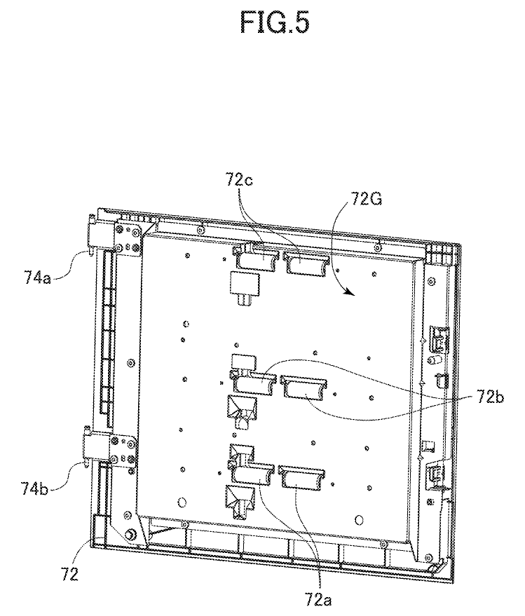

Next, a configuration around the vertical path 70 illustrated in FIGS. 1 and 2 will be described with reference to FIGS. 3 to 5. FIG. 3 is a perspective view illustrating a vertical path conveyance unit. FIG. 4 is a perspective view illustrating a feeding unit. FIG. 5 is a perspective view illustrating a vertical path conveyance door.

As illustrated in FIGS. 1 or 2 , the image forming apparatus 1A or 1B includes a vertical path 70 that guides a sheet fed from the cassette unit 51a or 51b to be conveyed upward. As illustrated in FIGS. 1, 2, and 5, a vertical path conveyance door 72 serving as a door portion is provided outside the vertical path 70 of the apparatus. The vertical path conveyance door 72 is provided to be openable and closable with respect to the casing 10 of the image forming apparatus 1A or 1B by upper and lower hinge portions 74a and 74b.

Further, the driven rollers 72a, 72b, and 72c are rotatably supported by the vertical path conveyance door 72. The vertical path conveyance door 72 has a guide surface 72G serving as a fourth guide portion that constitutes at least a part of a guide surface on the outer side (one side in the horizontal direction) of the vertical path 70 when the vertical path conveyance door 72 is closed with respect to the casing 10. In addition, the vertical path conveyance door 72 is configured such that a user or a serviceman can access the vertical path 70 when the vertical path conveyance door 72 is opened with respect to the casing 10. Therefore, paper jam clearance and roller replacement can be easily performed, thereby improving maintainability. The vertical path conveyance unit 73 and a conveyance guide 78 serving as a conveyance unit are provided beside the cassette unit 51b above the feeding unit 53a of the image forming apparatus 1A or 1B. The vertical path rollers 57a, 77, and 57b facing the driven rollers 72a, 72b, and 72c are provided in the feeding unit 53a, the vertical path conveyance unit 73, and the feeding unit 53b, respectively.

The driven rollers 72a, 72b, and 72c are configured to rotate following the vertical path rollers 57a, 77, and 57b, respectively. That is, the driven roller 72b can nip and convey a sheet together with the vertical path roller 77. As illustrated in FIG. 3, the vertical path conveyance unit 73 has a guide surface 73G that guides a sheet by forming at least a part of the vertical path 70, and attached portions 73F and 73R provided at front and rear side ends of the apparatus, respectively. Further, a drive gear 79 for inputting a driving force of the vertical path roller 77 is fixed to one portion end of a rotation shaft of the vertical path roller 77.

On the other hand, as illustrated in FIGS. 1 and 2, the vertical path rollers 57a and 57b facing the driven rollers 72a and 72c are provided in the feeding units 53a and 53b of the cassette units 51a and 51b, respectively. The driven roller 72ais configured to rotate following the vertical path roller 57a. In other words, the driven roller 72acan nip and convey a sheet together with the vertical path roller 57a. In addition, the driven roller 72c is configured to rotate following the vertical path roller 57b. In other words, the driven roller 72c can nip and convey a sheet together with the vertical path roller 57b.

As illustrated in FIG. 4, the feeding units 53a and 53b have guide surfaces 53aG and 53bG that guide a sheet by forming at least parts of the vertical path 70, and attached portions 53aF, 53bF, 53aR, and 53bR provided at front and rear side ends of the apparatus, respectively. Further, drive gears 59aand 59bfor inputting driving forces of the vertical path rollers 57a and 57b are fixed to one end portions of rotation shafts of the vertical path rollers 57a and 57b. In the present embodiment, the guide surface 53bG constitutes a first guide portion, the guide surface 53aG constitutes a third guide portion, and the guide surface 73G constitutes a second guide portion.

### Attachment to Frame

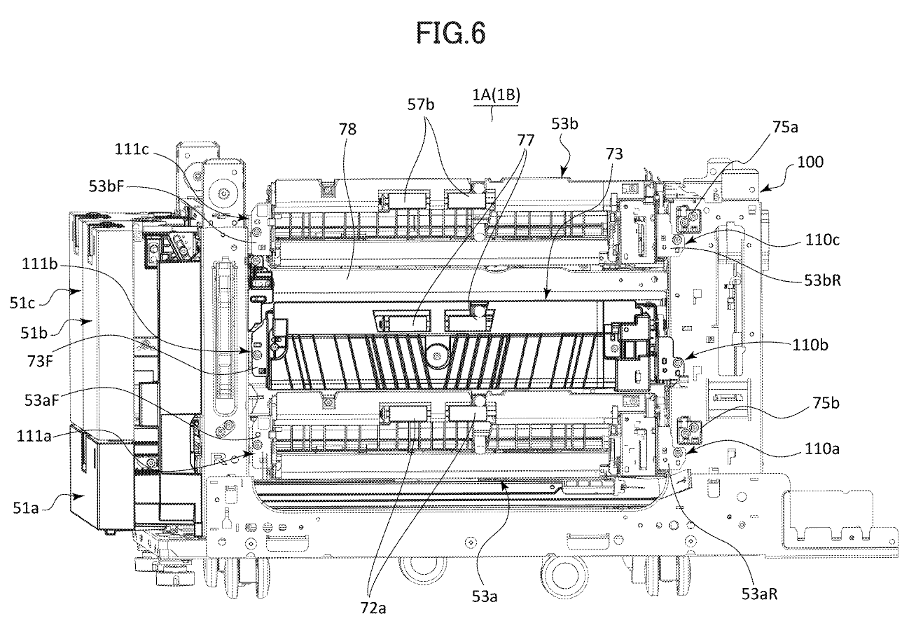

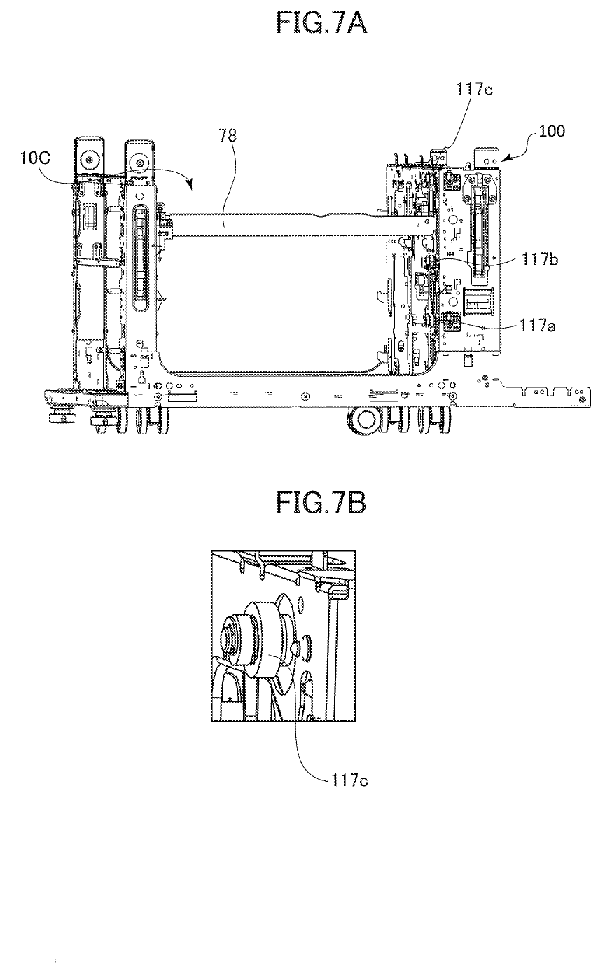

Next, the attachment of the feeding unit 53a, the vertical path conveyance unit 73, and the feeding unit 53b to the main body frame 100 common to the image forming apparatuses 1A and 1B will be described with reference to FIGS. 6, 7A, and 7B, . FIG. 6 is a perspective view illustrating a frame to which a cassette feeding unit and a vertical path conveyance unit are attached. FIG. 7A is a side view illustrating a main body frame from which a vertical path conveyance unit and a cassette feeding unit are detached. FIG. 7B is an enlarged view illustrating a portion including a coupling drive gear.

### Attachment Structure

As illustrated in FIG. 6, the main body frame 100 has engagement portions 75a and 75b with which the hinge portions 74a and 74b of the vertical path conveyance door 72 are engaged. In addition, the main body frame 100 includes attaching portions 111a, 111b, and 111c provided on the front side of the apparatus and attaching portions 110a, 110b, and 110c provided on the rear side of the apparatus. In the present embodiment, the attaching portion 111c and the attaching portion 110c arranged in order from top to bottom constitute a first attaching portion, the attaching portion 111b and the attaching portion 110b constitute a second attaching portion, and the attaching portion 111a and the attaching portion 110a constitute a third attaching portion.

The attached portion 53aF of the feeding unit 53a is attached to the attaching portion 111a, and the attached portion 53aR of the feeding unit 53a is attached to the attaching portion 110a. Positioning bosses are provided in the attaching portions 111a and 110a, respectively, and the attached portions 53aF and 53aR are fastened together by screws while the positioning bosses are inserted into positioning holes formed in the attached portions 53aF and 53aR. In this manner, the feeding unit 53a is positioned and fixed to the main body frame 100. In the present embodiment, the attached portions 53aF and 53aR constitute a third attached portion.

Similarly, the attached portion 73F of the vertical path conveyance unit 73 is attached to the attaching portion 111b, and the attached portion 73R of the vertical path conveyance unit 73 is attached to the attaching portion 110b. Positioning bosses are provided in the attaching portions 111b and 110b, respectively, and the attached portions 73F and 73R are fastened together by screws while the positioning bosses are inserted into positioning holes formed in the attached portions 73F and 73R. In this manner, the vertical path conveyance unit 73 is positioned and fixed to the main body frame 100. In the present embodiment, the attached portions 73F and 73R constitute a second attached portion.

Similarly, the attached portion 53bF of the feeding unit 53b is attached to the attaching portion 111c, and the attached portion 53bR of the feeding unit 53b is attached to the attaching portion 110c. Positioning bosses are provided in the attaching portions 111c and 110c, respectively, and the attached portions 53bF and 53bR are fastened together by screws while the positioning bosses are inserted into positioning holes formed in the attached portions 53bF and 53bR. In this manner, the feeding unit 53bis positioned and fixed to the main body frame 100. In the present embodiment, the attached portions 53bF and 53bR constitute a first attached portion.

The attaching portions 111a, 111b, and 111c provided on the front side of the apparatus and the attaching portions 110a, 110b, and 110c provided on the rear side of the apparatus have the same configuration, that is, are configured to the same standard. In addition, the attached portions 53aF, 73F, and 53bF and the attached portions 53aR, 73R, and 53bR in the feeding unit 53a, the vertical path conveyance unit 73, and the feeding unit 53b have the same configuration, that is, are configured to the same standard. As a result, the feeding units 53a and 53b and the vertical path conveyance unit 73 can be attached to any of the three positions in the vertical direction of the main body frame 110, in other words, their positions can be interchanged. Therefore, as in the second embodiment to be described in detail below, the attachment positions of the feeding units 53a and 53b with respect to the main body frame 100 can be changed without changing the configuration of the main body frame 100 or the configuration of the feeding units 53a and 53b.

In addition, the vertical path conveyance door 72 includes driven rollers 72c, 72b, and 72a arranged in order from top to bottom, and the driven rollers 72c, 72b, and 72a have the same configuration, that is, are configured to the same standard. In addition, the vertical path roller 57aof the feeding unit 53a, the vertical path roller 77 of the vertical path conveyance unit 73, and the vertical path roller 57b of the feeding unit 53b have the same configuration, that is, are configured to the same standard. As a result, the driven rollers 72c, 72b, and 72acan abut on the vertical path roller 57a of the feeding unit 53a, the vertical path roller 77 of the vertical path conveyance unit 73, and the vertical path roller 57b of the feeding unit 53b, regardless of which of the three attaching portions the feeding unit 53a, the vertical path conveyance unit 73, and the feeding unit 53b are attached to. Therefore, the feeding unit 53a, the vertical path conveyance unit 73, and the feeding unit 53b constituting the vertical path 70 can be attached to any of the three attaching portions without changing the designs of the main body frame 100 and the casing 10, and the attachment positions can be changed.

Note that the conveyance guide 78 (see FIGS. 1 and 2) provided above the vertical path conveyance unit 73 is provided to adjust a space in the height direction when the feeding unit 53b is disposed above the vertical path conveyance unit 73. That is, in the present embodiment, since the cassettes 52b and 52c become larger in the vertical direction as the large-size cassette is arranged in a single stage, and are larger in the vertical direction than the vertical path conveyance unit 73, the conveyance guide 78 is provided so that a sheet does not deviate from the vertical path 70.

### Drive Coupling Configuration

As illustrated in FIGS. 7A and 7B, the main body frame 100 includes coupling drive gears 117a, 117b, and 117c arranged side by side in the vertical direction so as to be rotatably driven inside the casing 10. The coupling drive gears 117a, 117b, and 117care drivingly coupled to a drive motor (not illustrated), and output driving forces to the drive gear 59a of the feeding unit 53a, the drive gear 79 of the vertical path conveyance unit 73, and the drive gear 59b of the feeding unit 53b.

That is, in a state where the attached portions 53aF and 53aR of the feeding unit 53a are attached to the attaching portion 111a and the attaching portion 110a, the coupling drive gear 117a is drivingly coupled to and meshed with the drive gear 59a of the feeding unit 53a. In addition, in a state where the attached portions 73F and 73R of the vertical path conveyance unit 73 are attached to the attaching portion 111b and the attaching portion 110b, the coupling drive gear 117b is drivingly coupled to and meshed with the drive gear 79 of the vertical path conveyance unit 73. Furthermore, in a state where the attached portions 53bF and 53bR of the feeding unit 53b are attached to the attaching portion 111c and the attaching portion 110c, the coupling drive gear 117c is drivingly coupled to and meshed with the drive gear 59b of the feeding unit 53b.

The driving forces input from the coupling drive gears 117a and 117c to the feeding units 53a and 53b drive the pickup rollers, the feed rollers, the retard rollers, and the vertical path rollers in the respective feeding units, and further drive lift-up mechanisms in the cassettes. The lift-up mechanism in the cassette 52aand the lift-up mechanism in the cassette 52b are different mechanisms, but the standards of the drive gears 59a and 59b that input driving forces are standardized.

That is, the coupling drive gears 117a, 117c, and 117b have the same configuration, that is, are configured to the same standard, so as to be meshed with the drive gears 59a and 59b of the feeding units 53a and 53b and the drive gear 79 of the vertical path conveyance unit 73, respectively. In the present embodiment, the coupling drive gear 117c, the coupling drive gear 117b, and the coupling drive gear 117a arranged in order from top to bottom constitute a first drive output unit, a second drive output unit, and a third drive output unit, respectively. In addition, the drive gear 59bof the feeding unit 53b constitutes a first drive input unit, the drive gear 79 of the vertical path conveyance unit 73 constitutes a second drive input unit, and the drive gear 59a of the feeding unit 53a constitutes a third drive input unit.

In short, the drive gear 59a of the feeding unit 53a can be drivingly coupled to the coupling drive gear 117a when the attached portions 53aF and 53aR of the feeding unit 53a are attached to the attaching portion 111a and the attaching portion 110a. In addition, the drive gear 59acan be drivingly coupled to the coupling drive gear 117b if the attached portions 53aF and 53aR of the feeding unit 53a are attached to the attaching portion 111b and the attaching portion 110b. Furthermore, the drive gear 59a can be drivingly coupled to the coupling drive gear 117c if the attached portions 53aF and 53aR of the feeding unit 53a are attached to the attaching portion 111c and the attaching portion 110c.

Similarly, the drive gear 79 of the vertical path conveyance unit 73 can be drivingly coupled to the coupling drive gear 117b when the attached portions 73F and 73R of the vertical path conveyance unit 73 are attached to the attaching portion 111b and the attaching portion 110b. In addition, the drive gear 79 can be drivingly coupled to the coupling drive gear 117a if the attached portions 73F and 73R of the vertical path conveyance unit 73 are attached to the attaching portion 111a and the attaching portion 110a. Furthermore, the drive gear 79 can be drivingly coupled to the coupling drive gear 117c if the attached portions 73F and 73R of the vertical path conveyance unit 73 are attached to the attaching portion 111c and the attaching portion 110c.

Similarly, the drive gear 59b of the feeding unit 53b can be drivingly coupled to the coupling drive gear 117b when the attached portions 53bF and 53bR of the feeding unit 53b are attached to the attaching portion 111b and the attaching portion 110b. In addition, the drive gear 59bcan be drivingly coupled to the coupling drive gear 117a if the attached portions 53bF and 53bR of the feeding unit 53b are attached to the attaching portion 111a and the attaching portion 110a. Furthermore, the drive gear 59bcan be drivingly coupled to the coupling drive gear 117c if the attached portions 53bF and 53bR of the feeding unit 53b are attached to the attaching portion 111c and the attaching portion 110c.

In this manner, the coupling drive gears 117a, 117b, and 117c, and the drive gears 59a and 59b of the feeding units 53a and 53b and the drive gear 79 of the vertical path conveyance unit 73 are configured to a common standard so as to be drivingly coupled regardless of which of the three attachment positions they are attached at. As a result, the feeding units and the vertical path conveyance unit are interchangeable, eliminating the need to design the image forming apparatus separately for each type and reducing the overall cost.

### Summary of First Embodiment

As described above, in the image forming apparatus 1A or 1B according to the present embodiment, two small-size cassettes 52b and 52c are installed on the left and right sides of the cassette installation portion 10C of the casing 10, and one large-size cassette 52a is installed below the two small-size cassettes 52b and 52c. The height in the vertical direction (that is, the sheet capacity) of the small-size cassettes 52b and 52c is three times or more the height in the vertical direction (that is, the sheet capacity) of the large-size cassette 52a. As a result, the cassettes 52b and 52c can cope with an increase in demand for sheets of an A4 size while the cassette 52a can cope with a demand for sheets of an A3 size. Therefore, by arranging the cassettes 52a, 52b, and 52c in the cassette installation portion 10C of the standardized casing 10, it is possible to reduce the number of times of replenishment of sheets of an A4 size, which are in high demand by users, without causing an increase in size, thereby improving productivity.

Further, in the image forming apparatus 1A or 1B according to the present embodiment, for example, the sheet capacity of the cassettes 52b and 52c is set to three times or more the sheet capacity of the cassette 52a, rather than a multiple including a decimal point, such as 2.5 times. That is, by setting the sheet capacity of the cassettes 52b and 52c to a multiple of a natural number or more, it is possible to replenish any cassette with one to three packs all at once, with one pack (500 sheets) being treated as one unit. As a result, it is possible to prevent remaining sheets from being generated when the pack is opened, thereby reducing the causes of paper jams and image defects.

In the first embodiment, it has been described that the small-size cassettes 52b and 52c have the same sheet capacity, each having a sheet capacity three times or more the sheet capacity of the large-size cassette 52a. However, as in the second embodiment to be described below, the small-size cassettes 52b and 52c may be configured to have different sheet capacities, such that an average of their sheet capacities is three times or more (six times or more in total). This also makes it possible to reduce the number of times of replenishment of sheets of an A4 size, which are in high demand by users, thereby improving productivity. In addition, when the average of the sheet capacities of the cassettes 52b and 52c is three times or more, six packs can be all replenished all at once into the cassettes 52b and 52c, thereby preventing remaining sheets from being generated when the packs are opened.

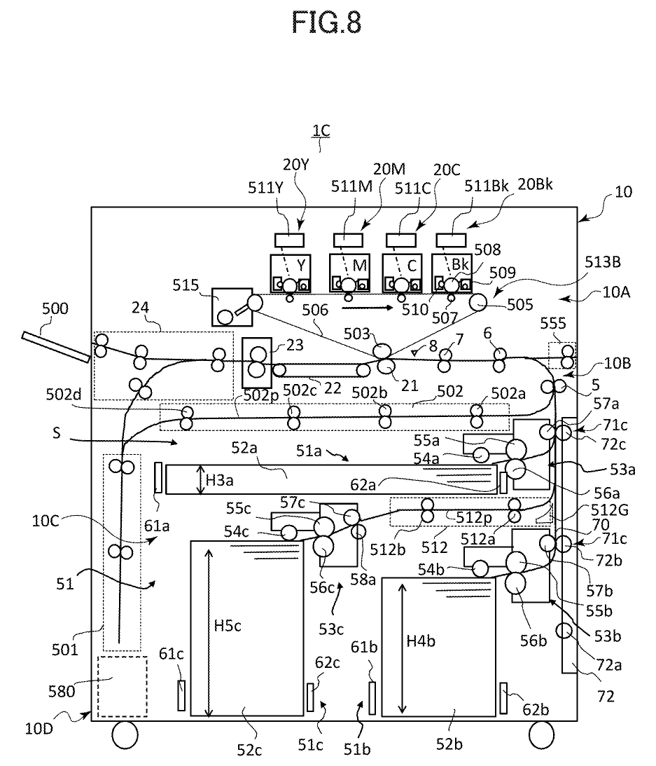

In the image forming apparatus 1A or 1B according to the present embodiment, the feeding unit 53c feeds a sheet from the cassette 52c to the double-sided printing path 502p, and conveys the sheet to the image forming unit 513A or 513B via the double-sided printing path 502p. As a result, when the sheet from the cassette 52c is conveyed to the image forming unit 513A or 513B, it is not necessary to form a conveyance path (see, for example, a horizontal conveyance path 512p in FIG. 8) for bypassing the cassette 52b for passage. Therefore, it is not necessary to reduce the height of the cassette 52b in the vertical direction, thereby preventing a decrease in sheet capacity of the cassette 52b. In addition, since the cassettes 52b and 52c can be configured in the same size as in the present embodiment, the parts can be standardized, making it possible to reduce the cost.

In the image forming apparatus 1A or 1B according to the present embodiment, the main body frame 100 has attaching portions 110c and 111c, attaching portions 110b and 111b, and attaching portions 110a and 111a arranged at three locations in order from top to bottom. Further, the feeding unit 53a, the vertical path conveyance unit 73, and the feeding unit 53b can be attached to any of the attaching portions in the vertical direction. In the image forming apparatus 1A or 1B according to the present embodiment, the feeding unit 53b is attached to the attaching portions 110c and 111c, the vertical path conveyance unit 73 is attached to the attaching portions 110b and 111b, and the feeding unit 53a is attached to the attaching portions 110a and 111a. As a result, it is possible to arrange the cassette 52a, which is a large-size cassette, in the lower stage and the cassette 52b, which is a small-size cassette, in the upper stage while forming the vertical path 70 without changing the designs of the main body frame 100 and the casing 10. In addition, since the three attaching portions arranged in the vertical direction are standardized, the arrangement of the cassettes and the vertical path conveyance unit can be freely changed without changing the design. Therefore, for example, an image forming apparatus 1C according to the second embodiment to be described below can also be configured without changing the designs of the main body frame 100 and the casing 10.

In addition, in the image forming apparatus 1A or 1B according to the present embodiment, the coupling drive gears 117c, 117b, and 117a arranged in order from top to bottom are provided inside the casing 10. The coupling drive gears 117c, 117b, and 117a can be drivingly coupled to the drive gear 59a of the feeding unit 53a, the drive gear 79 of the vertical path conveyance unit 73, and the drive gear 59b of the feeding unit 53b regardless of which of the three attaching portions the feeding unit 53a, the vertical path conveyance unit 73, and the feeding unit 53b are attached to. Therefore, it is possible to attach the feeding unit 53a, the vertical path conveyance unit 73, and the feeding unit 53b to any of the three attaching portions without changing the designs of the main body frame 100 and the casing 10.

In addition, in the image forming apparatus 1A or 1B according to the present embodiment, the vertical path conveyance door 72 includes driven rollers 72c, 72b, and 72a arranged in order from top to bottom. Then, the driven rollers 72c, 72b, and 72acan abut on the vertical path roller 57a of the feeding unit 53a, the vertical path roller 77 of the vertical path conveyance unit 73, and the vertical path roller 57b of the feeding unit 53b, regardless of which of the three attaching portions the feeding unit 53a, the vertical path conveyance unit 73, and the feeding unit 53b are attached to. Therefore, the feeding unit 53a, the vertical path conveyance unit 73, and the feeding unit 53b constituting the vertical path 70 can be attached to any of the three attaching portions without changing the designs of the main body frame 100 and the casing 10.

In the image forming apparatus 1A or 1B according to the present embodiment, one of the image forming unit 513A that forms a monochrome image on a sheet and the image forming unit 513B that forms a color image on a sheet can be selectively installed in the image forming installation portion 10A. As a result, the first-type image forming apparatus 1A and the second-type image forming apparatus 1B can use the common casing 10, the main body frame 100 can also be standardized, thereby making it possible to reduce the cost.

### Second Embodiment

Next, a second embodiment partially modified from the first embodiment will be described with reference to FIG. 8. FIG. 8 is an overall schematic view illustrating a third-type image forming apparatus according to the second embodiment. In the description of the second embodiment, the same reference signs are used for the parts that are the same as those in the first embodiment, and the description thereof will be omitted.

In a third-type image forming apparatus 1C according to the second embodiment, the cassette units 51b and 51c having cassettes 52b and 52c, which are two small-size cassettes arranged side by side on the left and right sides, are arranged in the lower stage. That is, in the image forming apparatus 1C, the cassette unit 51a having a cassette 52a, which is one large-size cassette, is arranged in the upper stage, and the cassette units 51b and 51c are arranged below the cassette unit 51a. Further, in the image forming apparatus 1C, a horizontal conveyance unit 512 having a horizontal conveyance path 512p serving as a third conveyance path is disposed so as to pass between the cassette unit 51a and the cassette unit 51b in the vertical direction. The horizontal conveyance unit 512 includes conveyance roller pairs 512b and 512a that convey a sheet on the horizontal conveyance path 512p.

In the image forming apparatus 1C, sheet separated and fed one by one from the cassette unit 51c are conveyed along the horizontal conveyance path 512p by the conveyance roller pairs 512b and 512a, the orientation of the sheet is changed by a conveyance guide 512G, and the sheet is conveyed to the vertical path 70. The sheet conveyed to the vertical path 70 is delivered to the merging roller pair 5. Note that the other operations in the image forming apparatus 1C are similar to those in the image forming apparatus 1B, and thus the description thereof will be omitted.

In the image forming apparatus 1C, since the horizontal conveyance unit 512 is provided, a stacking height H4b of the right cassette 52b and a stacking height H5c of the left cassette 52c are different, that is, their sheet capacities are different.

The stacking height H3a of the cassette 52a, which is a large cassette, in the image forming apparatus 1C according to the second embodiment will be expressed as a ratio in terms of sheet capacity (height) as in the first embodiment. In the image forming apparatus 1C according to the second embodiment, the ratio of the average of the sheet capacity (stacking height H4b) of the right cassette 52b and the sheet capacity (stacking height H5c) of the left cassette 52c to the sheet capacity (stacking height H3a) of the cassette 52a is about 3:1. That is, the average of the heights of the cassettes 52b and 52c in the vertical direction is three times or more the height of the cassette 52a in the vertical direction.

Specifically, the average stacking height of the stacking height H5c (180 mm) of the cassette 52c and the stacking height H4b (155 mm) of the cassette 52b is 167.5 mm (=(180+155)/2). When the cassette 52a has a stacking height H3a (55 mm), the ratio is 167.5 mm to 55 mm (3.05 to 1). That is, more preferably, the average of the heights of the cassettes 52b and 52c in the vertical direction is greater than three times the height of the cassette 52a in the vertical direction.

For example, one sheet having a grammage of 80 GSM has a thickness of 0.105 mm per sheet. Therefore, the sheet capacity of the cassette 52a, which is a large-size cassette, is about 520 sheets (55 mm/0.105 mm). In addition, the sheet capacity of the cassette 52b, which is a small-size cassette, is about 1470 sheets (155mm/0.105 mm), and the sheet capacity of the cassette 52c, which is a small-size cassette, is about 1710 sheets (180 mm/0.105 mm). Assuming that one pack contains 500 sheets, the sheet capacity of the cassette 52a is one pack and 20 sheets, and the total sheet capacity of the two cassettes 52b and 52c is six packs and 180 sheets.

Further, for example, one sheet having a grammage of 64 GSM has a thickness of 0.089 mm per sheet. The sheet capacity of the cassette 52a, which is a large-size cassette, is about 610 sheets (60 mm/0.089 mm). In addition, the sheet capacity of the cassette 52b, which is a small-size cassette, is about 1740 sheets (155 mm/0.089 mm), and the sheet capacity of the cassette 52c, which is a small-size cassette, is about 2020 sheets (180 mm/0.089 mm). Assuming that one pack contains 500 sheets, the sheet capacity of the cassette 52a is one pack and 110 sheets, and the total sheet capacity of the two cassettes 52b and 52c is seven packs and 260 sheets.

Note that, in the image forming apparatus 1C according to the second embodiment, the cassettes 52b and 52c, which are left and right small-size cassettes, are arranged at locations near the bottom plate of the casing 10, where rigidity is high. Therefore, it can be said that the overall rigidity design of the casing 10 and the main body frame 100 is advantageous as compared with that in the image forming apparatus 1A or 1B according to the first embodiment. In other words, the arrangement of two small-size cassettes 52b and 52c and one large-size cassette 52a can be determined in consideration of design requirements such as the overall rigidity of the casing 10 and the main body frame 100.

In addition, although the image forming apparatus 1C according to the second embodiment has been described as including a color image forming unit 513B, the monochrome image forming unit 513A may be installed in the image forming installation portion 10A.

Further, in the image forming apparatus 1C according to the second embodiment, the cassette 52b having a larger height than the cassette 52a is disposed in the lower stage. Therefore, the feeding unit 53a that feeds a sheet from the cassette 52a is attached to the attaching portions 110c and 111c, and the feeding unit 53b that feeds a sheet from the cassette 52b is attached to the attaching portion 110b and 111b (see FIG. 6). In addition, since there is no cassette below the cassette 52b, there is no need to attach the vertical path conveyance unit 73 to the attaching portions 110a and 111a, and nothing is attached thereto.

In summary, the image forming apparatus 1C according to the second embodiment is different from the image forming apparatus 1A or 1B according to the first embodiment in that the provision of the horizontal conveyance unit 512 changes the heights of the cassettes 52b and 52c. However, since the cassettes 52b and 52chaving large sheet capacities are arranged in the lower stage, it is advantageous in terms of the overall rigidity of the casing 10 and the main body frame 100. In addition, since the cassettes 52band 52chaving large sheet capacities are arranged in the lower stage, it is not necessary to install the vertical path conveyance unit 73.

The other configurations, operations, and effects of the second embodiment are the same as those of the first embodiment, and thus the description thereof will be omitted.

### Other Possible Embodiments

In the first and second embodiments described above, one of the monochrome image forming unit 513A and the color image forming unit 513B can be selectively installed in the image forming installation portion 10A, but the image forming unit is not limited thereto. That is, any image forming unit may be installed, and the size of the image forming apparatus may be changed accordingly. As an example, the monochrome image forming unit 513A may be configured as a direct transfer-type image forming unit without the intermediate transfer belt 506 to reduce the sizes of the monochrome image forming unit and the image forming installation portion 10A, thereby reducing the size of the image forming apparatus. Even in such a configuration, by setting the average of the sheet capacities of the small-size cassettes 52b and 52c to three times or more the sheet capacity of the large-size cassette 52a, it is possible to reduce the number of times of replenishment of small-size (A4-size) sheets desired by users.

In addition, in the first and second embodiments, it has been described that the image forming installation portion 10A (image forming unit) is disposed in a relatively upper portion, and the cassette installation portion 10C (a plurality of cassettes) is disposed in a relatively lower portion, but their locations are not limited thereto. Conversely, the image forming installation portion 10A may be disposed in a lower portion, and the cassette installation portion 10C may be disposed in an upper portion.

In the first and second embodiments, it has been described that the small-size cassettes store one or more sheets of an A4 size, and the large-size cassette stores one or more sheets of an A3 size. However, the cassettes are not limited thereto, and for example, in a case where a user desires to set B4 size sheets and B5 size sheets, a plurality of cassettes may be arranged in that manner. In particular, for a user who has a greater demand for small-size sheets than for large-size sheets, it is conceivable to set the average of the sheet capacities of the small-size cassettes 52b and 52c to three times or more the sheet capacity of the large-size cassette 52a.

In the second embodiment, it is illustrated in FIG. 8 that the driven roller 72a is provided in the vertical path conveyance door 72, but the vertical path conveyance door 72 is not limited thereto, and the driven roller 72a may be eliminated from the vertical path conveyance door 72. In this case, the other configurations can be standardized, without attaching the driven roller 72a to the vertical path conveyance door 72.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-064099, filed April 9, 2025, which is hereby incorporated by reference herein in its entirety.

What is claimed is:

1. An image forming apparatus comprising:
an image forming unit configured to form an image on a sheet;
a plurality of cassettes configured to store one or more sheets to be fed to the image forming unit; and
a casing including an image forming installation portion in which the image forming unit is installed, and a cassette installation portion in which the plurality of cassettes are attached and installed, the cassette installation portion being disposed below the image forming installation portion,
wherein the plurality of cassettes includes:
a first cassette configured to store one or more sheets of a first size to be fed to the image forming unit,
a second cassette configured to store one or more sheets of the first size to be fed to the image forming unit, the second cassette being disposed on one side of the first cassette in a horizontal direction, and
a third cassette configured to store one or more sheets of a second size larger than the sheets of the first size to be fed to the image forming unit, the third cassette being disposed below the first cassette and the second cassette, and
wherein a height of each of the first cassette and the second cassette in a vertical direction is greater than three times a height of the third cassette in the vertical direction.

2. The image forming apparatus according to claim 1, wherein
a stacking height of each of the first cassette, the second cassette, and the third cassette is determined depending on a number of sheets stackable in each of the cassettes.

3. An image forming apparatus comprising:
an image forming unit configured to form an image on a sheet;
a plurality of cassettes configured to store one or more sheets to be fed to the image forming unit; and
a casing including an image forming installation portion in which the image forming unit is installed, and a cassette installation portion in which the plurality of cassettes are attached and installed, the cassette installation portion being disposed below the image forming installation portion,
wherein the plurality of cassettes includes:
a first cassette configured to store one or more sheets of a first size to be fed to the image forming unit,
a second cassette configured to store one or more sheets of the first size to be fed to the image forming unit, the second cassette being disposed on one side of the first cassette in a horizontal direction, and
a third cassette configured to store one or more sheets of a second size larger than the sheets of the first size to be fed to the image forming unit, the third cassette being disposed below the first cassette and the second cassette, and
wherein a number of sheets stackable in each of the first cassette and the second cassette is greater than three times a number of sheets stackable in the third cassette.

4. The image forming apparatus according to claim 3, wherein
a number of sheets stackable in each of the first cassette, the second cassette, and the third cassette is determined depending on a grammage of each of the sheets stacked in each of the cassettes.

5. An image forming apparatus comprising:
an image forming unit configured to form an image on a sheet;
a plurality of cassettes configured to store one or more sheets to be fed to the image forming unit; and
a casing including an image forming installation portion in which the image forming unit is installed, and a cassette installation portion in which the plurality of cassettes are attached and installed, the cassette installation portion being disposed below the image forming installation portion,
wherein the plurality of cassettes includes:
a first cassette configured to store one or more sheets of a first size to be fed to the image forming unit,
a second cassette configured to store one or more sheets of the first size to be fed to the image forming unit, the second cassette being disposed on one side of the first cassette in a horizontal direction, and
a third cassette configured to store one or more sheets of a second size larger than the sheets of the first size to be fed to the image forming unit, the third cassette being disposed below the first cassette and the second cassette, and
wherein the plurality of cassettes does not include a fourth cassette configured to store one or more sheets, the fourth cassette being disposed below the third cassette in a vertical direction.

6. The image forming apparatus according to claim 1, further comprising:
a first feeding unit configured to feed the one or more sheets stored in the first cassette,
a second feeding unit configured to feed the one or more sheets stored in the second cassette,
a third feeding unit configured to feed the one or more sheets stored in the third cassette,
a first conveyance path configured to convey a sheet toward the image forming unit, the first conveyance path being disposed so as to extend in the vertical direction on the other side of the first cassette in the horizontal direction, and
a second conveyance path configured to convey back, toward the image forming unit, a sheet having an image formed by the image forming unit on a first side thereof, the second conveyance path being disposed so as to extend in the horizontal direction above the first cassette and the second cassette, wherein
the first feeding unit and the third feeding unit feed a sheet to the first conveyance path, and
the second feeding unit feeds a sheet to the second conveyance path.

7. The image forming apparatus according to claim 1, wherein
one of a first image forming unit configured to form a monochrome image on a sheet and a second image forming unit configured to form a color image on a sheet can be selectively installed in the image forming installation portion.

8. The image forming apparatus according to claim 1, wherein
the sheet of the first size is a sheet of an A4 size, and
the sheet of the second size is a sheet of an A3 size.
